(19) United States
(12) Patent Application Publication
(10) Pub. No.: US 2008/0005276 A1
(43) Pub. Date: Jan. 3, 2008

(54) Method for delivering exercise programming by streaming animation video

(76) Inventor: Joanne M. Frederick, Fulton, MD (US)

Correspondence Address: Ober, Kaler, Grimes & Shriver;Attorneys at Law, 120 East Baltimore Street, Baltimore, MD, 21202-1643, US

(21) Appl. No.: 11/804,993

(22) Filed: May 21, 2007

Related U.S. Application Data
(60) Provisional application No. 60/801,655, filed on May 19, 2006.

(51) Int. Cl. G06F 15/16; G06F 3/00

(52) U.S. Cl. 709/218; 715/719

(57) ABSTRACT

An online web portal and method of providing exercise through interactive Internet access. The method generally comprises the steps of subscribing users and requiring them to input user attributes such as sex, height and weight; logging subscribed users into the web portal; providing a library of exercise content including a plurality of animated exercise routines (authored in advance using an animated personal coach); providing an efficient multi-selection method for subscribed users to select a desired exercise routine as efficiently as possible; and providing an animation playback window with motion and volume controls for allowing a subscribing user to control playback of their selected animated exercise routines. With this method subscribers can exercise in a coached format in the privacy of their home. A full calendar feature is provided to allow scheduling and track of exercise routines. Moreover, at registration the portal generates an icon representative of the user based on the user attributes, and as time goes on the icon evolves to reflect the improved conditioning of the subscriber as they progress.

### CROSS-REFERENCE TO RELATED APPLICATIONS

The present application derives priority from U.S. Provisional Application Ser. No. 60/801,655 filed May 19, 2006.

### BACKGROUND OF THE INVENTION

1. Field of the Invention

The present invention relates to health services and, more particularly, to a subscription-based method for providing users with in-home exercise and wellness routines by a web portal adapted for streaming video of animated exercise routines over the Internet for improving health, fitness and well-being.

2. Description of the Background

The exercise industry is booming. According to the American Obesity Association, consumers spend over $30 billion each year on weight loss programs. A 2002 Health Trend Report estimates that the commercial health club industry provided health and fitness services to over 36.3 million health club members and generated $13.1 billion in revenue. Unfortunately, many providers of these services are far from effective. This is largely due to problems with the current methods of exercise delivery. Exercise programs are currently delivered in many traditional forms. Individuals can buy exercise videos, join a gym, hire a personal trainer, subscribe to a fitness magazine or buy a book. However, according to a report published in Medical News Today in May 2005, over 80% of the individuals that pay for a gym membership are not using them. While people enjoy participating in exercise classes they just don't like commuting to a gym, or don't like the group dynamic. Home videos offer an alternative, but people tend to get bored with the same workout videos and fail to keep a routine. There are cable TV exercise shows that offer variety, but these cannot provide any degree of personalization or choice in one's exercise routine or when to exercise. There are a few online fitness and wellness programs, but these are limited to static photographs of exercises, online personal trainers that provide advice, and web portals that have members record their exercise and food consumption for diet programs.

In light of the foregoing, it would be of great advantage to create an online interactive system to help individuals improve their health, fitness, and wellness delivering a rich array of exercise and fitness content to the home via streaming video animation.

### SUMMARY OF THE INVENTION

It is therefore an object of the present invention to provide an online interactive system to help individuals improve their fitness by web-delivery of steaming exercise video content.

It is another object of the present invention to provide an online web portal for delivery of exercise content that offers a better combination of affordability, flexibility, online community and value.

It is still another object to provide a subscription-based online web portal for delivery of exercise content that allows subscribers to work out at their convenience based on the time and equipment they have available.

It is still another object to provide an online web portal for delivery of streaming video exercise content that encourage subscribers to work out in manageable increments throughout the day.

It is another object to provide an online web portal for delivery of streaming video exercise content that includes a personalized calendar to allow subscribers to schedule workouts, inclusive of video workouts to exercise content within the site as well as outside activities such as walking at lunch. The personalized calendar with the content of the site is an important component to help people plan and manage their exercise goals.

These and other objects are accomplished by providing a web portal for providing exercise through interactive Internet access. The method generally comprises the steps of: (a) subscribing users and requiring input of user attributes; (b) requiring subscribed users to login to a web portal; (c) providing a library of exercise content including a plurality of animated exercise routines (authored in advance using an animated personal coach); (d) providing a dual-selection method for subscribed users to select a desired exercise routine by either categorical index or attribute search window for quickest possible selection; and (e) providing an animation playback window with motion and volume controls for allowing a subscribing user to control playback of their selected animated exercise routines. In addition, a full calendar feature is provided to allow scheduling and track of exercise routines.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a top level flow diagram of the web portal according to the present invention.

FIG. 2 is a screen print of an exemplary home page.

FIG. 3 is a screen print of an exemplary Personal Calendar page.

FIG. 4 is a diagram of the indexed method of exercise content selection.

FIG. 5 is a diagram of the cross-reference for exercise content selection.

FIG. 6 is a screen print of the main Exercise Page.

### DETAILED DESCRIPTION OF THE PREFERRED EMBODIMENTS

The present invention is a system inclusive of a method and web-implemented software for delivering streaming video of animated exercise routines over the Internet for improving health, fitness and well-being of subscribers. The software is preferably deployed on one or more web-enabled backend servers hosting a resident database and user interface in the form of a website that can be reached by users at an appropriately named URL such as, for example, www.cybercise.com. The back-end web-enabled server(s), database and website are maintained by a third party application service provider (‘ASP’), and all user-ASP communication may take place over the Internet.

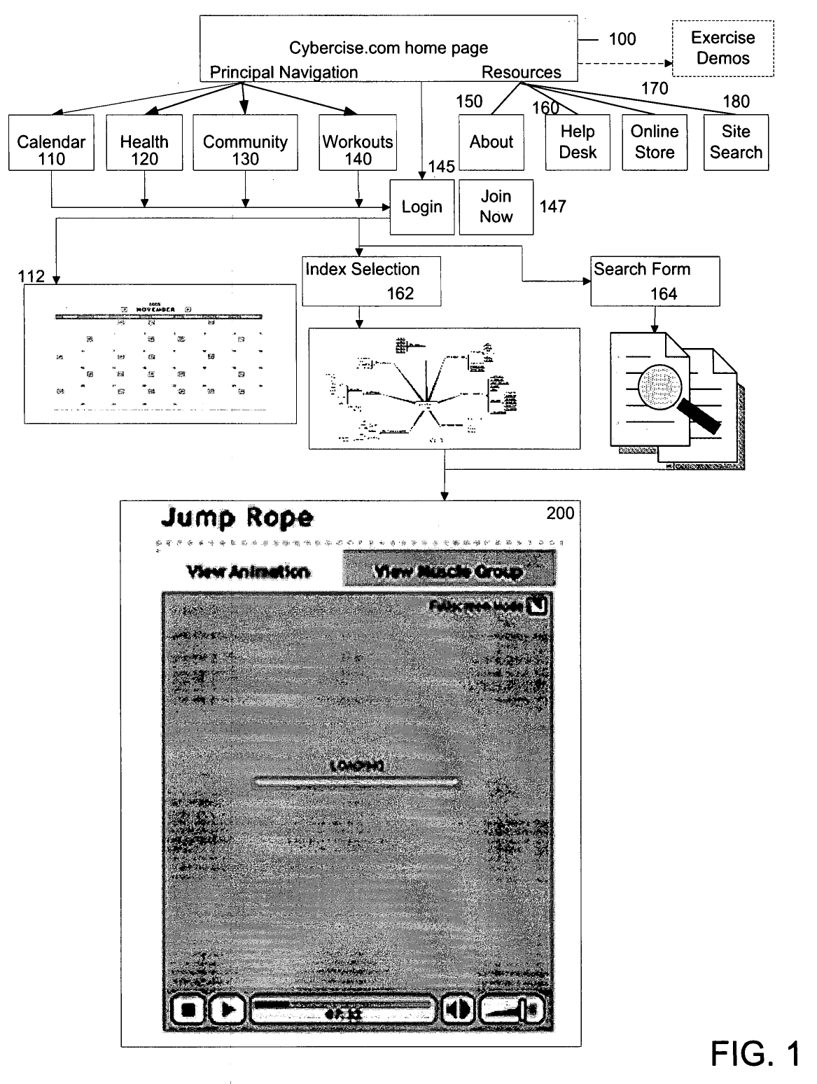

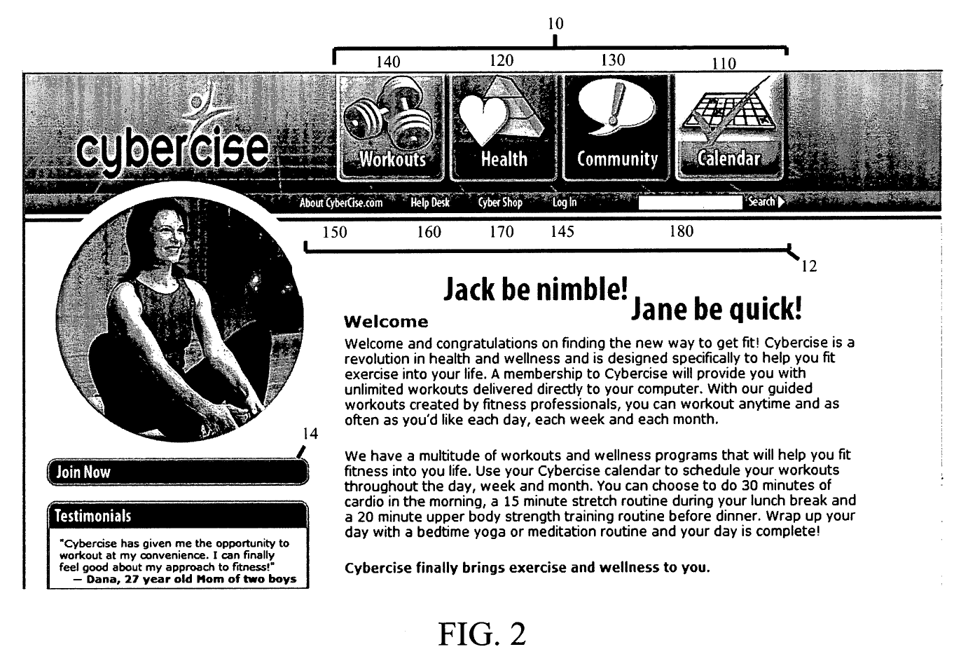

FIG. 1 is a top level flow diagram of the web-implemented software which embodies the method of the present invention. FIG. 2 is a screen print of an exemplary home page. With combined reference to FIGS. 1 and 2, the home page generally displays welcoming graphics and a message such as shown, enticing user testimonials (bottom left), and provides the main navigation controls for accessing site content. The navigation controls include principal section buttons 10 that link to the main subscriber sections of the site, a user resource menu bar 12, and a “join now” button 14.

At Step 100, a user accesses the website and is confronted with the home page. To access any of the main subscriber sections of the site via section buttons 10, the user must login. Any unauthorized attempt to access will redirect the user to a login page at step 145 which requires entry of a User Name (Email) and Password. Alternately, the login page at step 145 may be accessed directly from the user resources links 12 on the home page. Any unauthorized attempt to access will redirect the user to the login page at step 145, where subscribing users may login directly. Unsubscribed users may join via the “join now” link 14 on the home page or an equivalent link appearing on any of the public content pages of the site. The join now link 14 and at step 147 engenders a Member Registration Screen that bears membership information and an electronic form for completion.

It is important to note that with a membership users gain access to all site content 24 hours a day, 7 days a week, so they can exercise as often as they like. This is much more convenient than a traditional gym membership because exercise regimens can be suited to daily schedules. For example, a user can do a quick yoga program before the kids wake up, a 10 minute stretch at work to release tension, and a strength program after work to increase muscle tone and fitness. Subscribers don't need to find time to go to the gym, don't have to worry about working out in front of strangers, and don't have to pay a babysitter for the kids. Membership fees entail a subscription fee (fore example, $10.00 to join) and a low monthly fee (for example, $9.95) each month thereafter. To register, the user inputs the required identification information and is also able to choose a registration timeframe. When subscribing new members enter their attributes such as sex, age, height, weight and body type.

As an optional feature the present system may generate an iconic likeness called “VirtualMe.” The icon is chosen from a library of pre-existing icons based on the user's height, weight and/or body type. Over time, as the subscriber makes progress toward their fitness goals and enters new data, they will be able to see their likeness improve in appearance and fitness. If desired, the system may give subscribers a preview of their new “VirtualMe” modified to reflect them at their ultimate fitness goal. The VirtualMe icon gives subscribers a sense of progress that is otherwise difficult to engender in an online setting.

After login at step 145 and/or joining the site at step 147 the registered subscriber is redirected to the home page where they can access the subscription-only content and freely navigate the site via the principal navigation buttons 10 at top, or alternatively via the resources menu bar 12 beneath. Specifically from the home page main subscriber section buttons 10, subscribers can easily select their personalized calendar at step 110, get health and dieting tips at step 120, join or participate in a community forum at step 130, or go to the Workout section at step 140. Other options available from the user resource menu bar 12 include reading about the ASP and site at step 150, a help desk at step 160, an online store at step 170 where the subscriber can purchase exercise equipment and apparel, and a site search function 180 for text-based searches of site content.

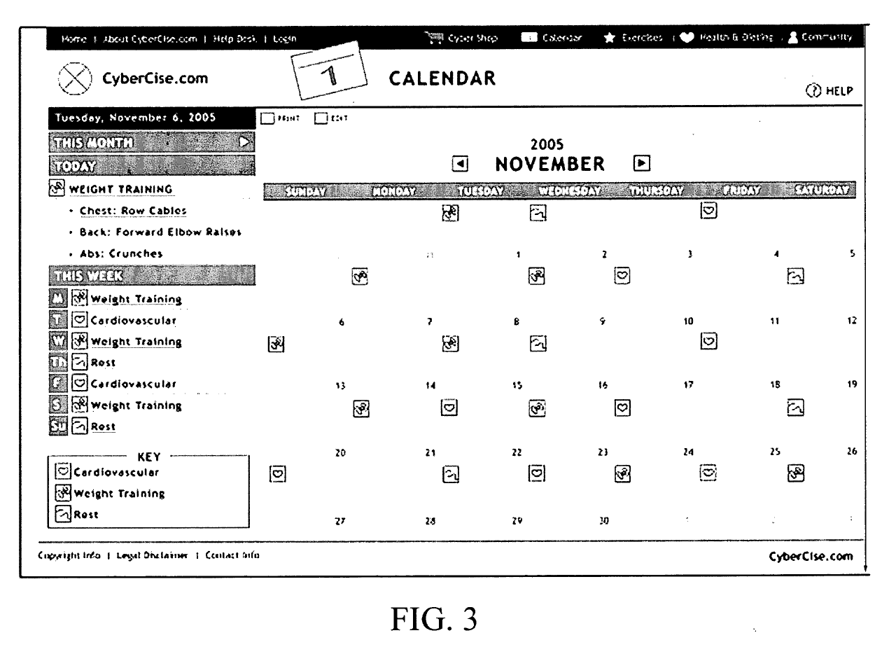

If, at step 110, the subscriber selects Personal Calendar, at step 112 they are directed to the Calendar page shown in FIG. 3. The Calendar page comprises a dual-pane calendar with text entries at left and a graphical monthly calendar at right. The text entries include an indication of the current date, and index tab folders containing the subscriber's planned exercise regimen on a monthly, weekly and daily basis. The subscriber can select monthly, weekly and daily views and open the corresponding folder to view their planned exercise regimen by category of exercise (cardiovascular, weight training, etc.). The subscriber may also click on the category to view the individual exercises to be performed in each category paired with the operative muscle groups (for example, weight training on chest, back and abs by row cables, elbow raises and crunches, respectively, as shown). The graphical monthly calendar at right provides a more intuitive display of scheduled exercises over an entire month with icons (heart, dumbbells, etc) representing each day's exercises. By clicking on any daily icon (or corresponding index tab) the subscriber can edit the exercise routine, and enter follow-up information such as whether the routine was completed, and general notes. This robust calendar feature enables subscribers to plan their workouts using the Content Selection feature (to be described), and each selected exercise is neatly scheduled on the subscriber's Personal Calendar. The portal software automatically generates an email reminder to the subscriber in advance to remind them of each scheduled workout, if they so choose. The Personal Calendar also allows the subscriber to track their progress in completing the workouts and, in so doing, incentivizes the subscriber to plan and adhere to their workout much more rigorously than previously possible.

The Personal Calendar page is also home to the subscriber's “VirtualMe” icon if this feature is implemented. As the subscriber makes progress toward their fitness goals and enters new data, their “VirtualMe” icon appears on the Personal Calendar page and visibly loses bulk or accumulates strength in accordance with the subscriber's entered progress. Through the optional “VirtualMe” icon the subscriber is able to see their likeness improve in appearance and fitness.

While not shown, a link may also be provided to Exercise Demos, which directs the user to a Demo page were they may sample condensed versions of the full content (to be described). These exercise demos are marketing materials intended primarily for unregistered users.

If, at step 120, if the subscriber selects Health/Dieting, they are given access to a newsletter-format array of articles and suggestions and links to other websites on healthy lifestyles, proper eating, exercising, dieting, etc.

If, at step 130, the subscriber selects Forum, they are given access to a user discussion forum. Here users can share experiences and suggestions. Subscribers can post, and all users can view the posts.

If, at step 150, if the subscriber selects “About”, they are given access to a bio page relating details about the site including the mission to improve the health and fitness of members by offering a wide variety of workout routines and wellness programs easily accessible via a personal computer.

If, at step 160, if the subscriber selects “Help Desk”, they are given access to a help page relating answers to frequently asked questions (FAQs) and providing email links and contact information to seek online or live assistance.

If, at step 170, the subscriber selects Online Store, they are given access to a storefront where they can purchase products. In addition to selling third-party products through its portal, a house-brand Cyber-cise line of products and apparel is available for web-purchase.

If, at step 180, the subscriber selects “search”, they are given access to a site search function which allows text-based entries for sire-wide searches of content.

Finally, if, at step 140 the subscriber selects “Exercises” (Content), they are given a decision on how to select their desired exercises.

At step 162 they may select an indexed menu, and at step 164 they may select a text-based search approach.

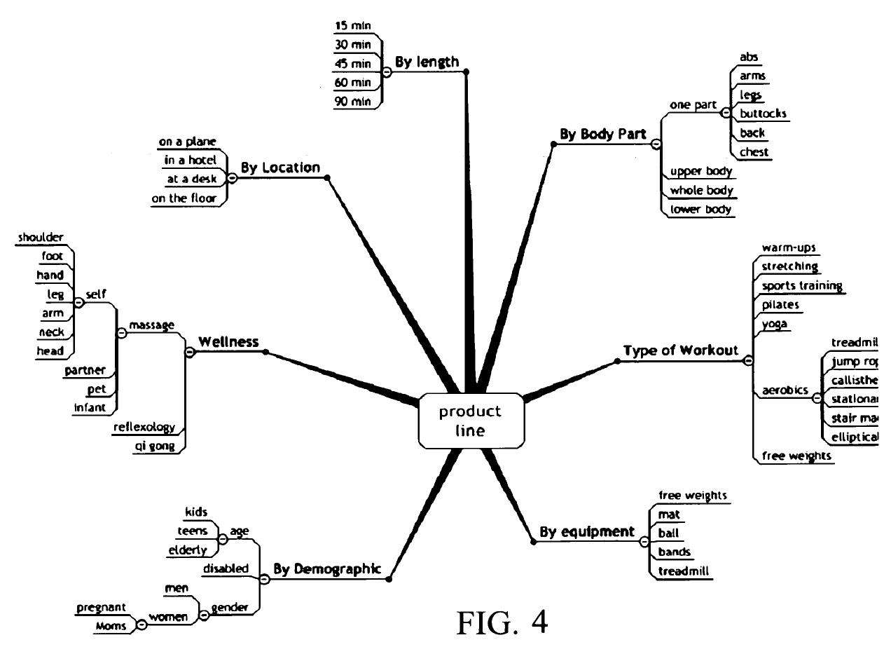

FIG. 4 illustrates the indexed approach to exercise selection. The subscriber is presented with an indexed selection of content arrayed in a tree-branch configuration broken down by categories and sub-categories. The subscriber first decides how they wish to select their exercise, the choices ranging from “By Length (duration)”, “By Body Part (to be exercised)”, “By Type (of workout)”, “By Type of Equipment (used in the workout)”, “By Demographic (sex, age, etc.)”, By Wellness” or “By Location (exercise site, e.g., in a hotel, outdoors, etc.)”. One skilled in the art will readily understand that other categories may be possible. The subscriber simply navigates the index to arrive at a particular exercise as follows:

By Length>>15 min, 30 min, 45 min, 60 min, 90 min.

By Body Part>>abs, arm, legs, buttocks, back, chest, upper body, whole body, lower body, etc.

By Type>>warm-ups, stretching, sports training, pilates, treadmill, jump rope, calisthentics, aerobics, etc.

By Type of Equipment>>stationery bike, stairmaster, elliptical, free weights, mat, ball, bands, treadmill, etc.

By Demographic>>kids, teens, elderly, disabled, men, pregnant women, women, etc.

By Wellness>>shoulder, foot, hand, leg, self, arm, neck, massage, head, etc.

By Location>>in a hotel, at a desk, on the floor, via a networked television set etc. By navigation through this index of categories and subcategories the subscriber finally arrives at a list of exercise programs that fit their criteria.

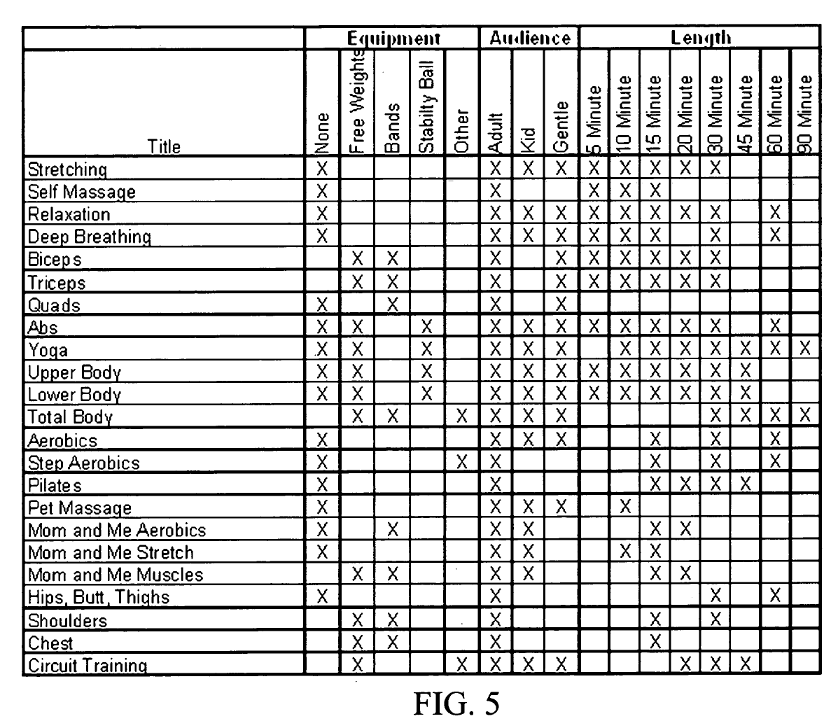

Alternatively, at step 164 the subscriber can type their constraints into a search form. The exercise content is maintained in a database and is abstracted by a matrix of descriptor fields as shown in FIG. 5 so that each segment of content can be referenced by its characteristics. The characteristics are the same as in FIG. 4, namely, Length (15 min, 30 min, 45 min, 60 min, 90 min); Body Part (abs, arm, legs, buttocks, back, chest, upper body, whole body, lower body); Type (warm-ups, stretching, sports training, pilates, treadmill, jump rope, calisthentics, aerobics); Type of Equipment (stationery bike, stairmaster, elliptical, free weights, mat, ball, bands, treadmill); Demographic (kids, teens, elderly, disabled, men, pregnant women, women); Wellness (shoulder, foot, hand, leg, self, arm, neck, massage, head); and Location (in a hotel, at a desk, on the floor, via network television). The subscriber is presented with a search window with drop-down lists of each characteristic and may select those desired, and run the search. By searching, all exercise content matching a desired search string will be returned.

Time to access a desired workout is minimized by the above-described dual selection method. Subscribers can go directly to their workout of choice via the Index, or can answer a few quick questions via a search page so the web application can provide them with a short list of workouts that meet their parameters. By either selection method, the subscriber may select a particular segment of exercise content for immediate play, or may schedule one in the Daily Calendar.

The content and indexing itself is maintained by the application service provider (ASP). The quality and quantity of the exercise content delivered to subscribers is of utmost importance, and a robust research and content development effort helps to retain subscriber interest and reduce membership turnover.

The subscriber makes their selection via indexed menu at step 162 or text-based search approach at step 164, and they are given the option of immediate or scheduled playback of the desired exercise sequence. To schedule a playback the subscriber is redirected to the Calendar at step 112 where they can pick a day or time for playback.

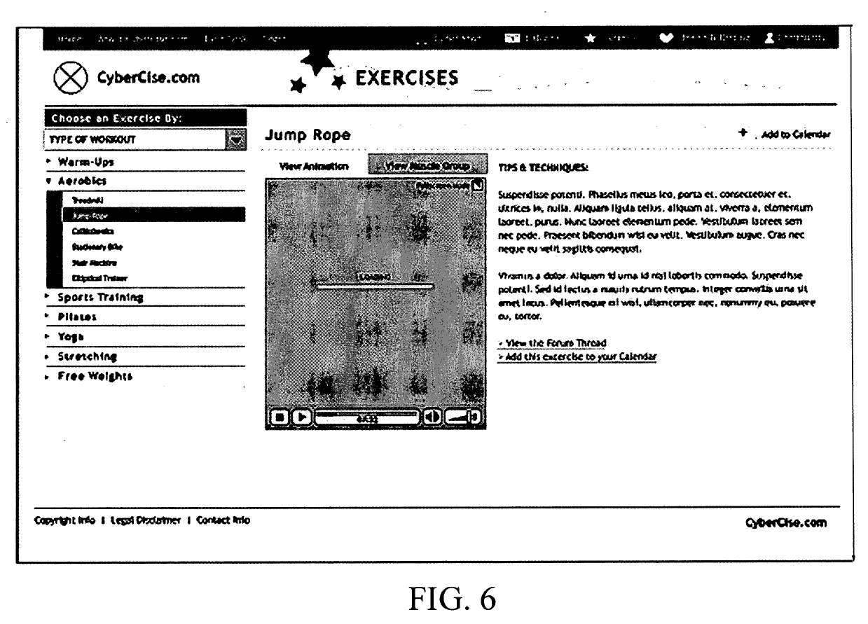

For immediate playback at step 200, the subscriber is directed to the Exercise Page of FIG. 6. The Exercise Page retains the indexed search menu 162 at the left and so gives the opportunity to revise the selection. The selection represents an audio/video clip that can be played directly in the Exercise page, which includes an embedded media player. Currently, Macromedia Flash™ technology is employed, and so the Exercise Page presents a MacroMedia Flash™ player window with appropriate audio and video controls beneath including start, stop, pause, rewind and fast forward. The selection may be played back in the Flash™ window and the subscriber follows instructions or follows the routine (if aerobics or the like). The Flash Player is a client application available in most dominant web browsers. It features support for vector and raster graphics, a scripting language called ActionScript and bidirectional streaming of audio and video. Flash is commonly used to play animations and advertisements, and a Flash authoring tool is available to design animations called “flash movies”. However, one skilled in the art will readily recognize that other media players may suffice, such as Windows Media Player™.

Each exercise sequence is preferably an earlier-authored Flash animation clip cross-referenced as an object in the underlying database. Each Flash animation may comprise a life-like animated character demonstrating and verbalizing each movement throughout the entire program. Use of an animated character helps to keep operating costs low, and yet suffices in every respect to lead the exercise routine. Moreover, Flash technology allows each subscriber's personal computer to share some of the processing load of the content. This eliminates some of the hosting equipment overhead and reduces the active bandwidth requirements. In addition, Flash technology incorporates privacy rights to prevent subscribers from downloading a personal copy of the content to enable us to protect our content from piracy. The Flash content animations are stored as embedded objects in the conventional database that is indexed (abstracted) as shown above in FIG. 5. When a selection is made the animation is called from the database and is loaded into the Flash Player on the Main Exercise Page. The subscriber chooses when to initiate the routine. Each routine is a full-length session, some being informative and some being participative. The animations are authored to create the perception of a personal coach.

To be entirely sure that the subscriber is exercising correctly, a “tips and techniques” window appears directly to the right of the Flash Player and this provides text descriptions and photographs of trainers demonstrating the move with detailed written instructions as additional support. The tips and techniques window also illustrates specifically what muscles groups are being worked with each program.

It should now be apparent that the above-described web portal provides a complete online interactive solution to help individuals improve their fitness by web-delivery of steaming exercise video content. The combination of Flash-animation playback of exercise routines, a dual selection approach, and robust calendar feature allow scheduling and tracking of exercise routines to suit any subscribers schedule, regardless of where they are so long as an internet-enabled PC computer is handy. For the first time subscribers can plan a targeted exercise regimen involving multiple workouts per day, and never need to travel to a gym. They can track whether a planned routine was completed, and monitor their progress. The combination of affordability, flexibility, online community and value incentivizes the subscriber to plan and adhere to their workout much more rigorously than previously possible.

Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim:

1. A method for providing exercise through interactive Internet access, comprising the steps of:
(a) subscribing users and requiring input of user attributes;
(b) requiring subscribed users to login to a web portal;
(c) providing a library of exercise content including a plurality of animated exercise routines;
(d) providing a dual-selection method for subscribed users to select a desired exercise routine by either categorical index or attribute search window;
(e) providing an animation playback window with motion and volume controls for allowing a subscribing user to control playback of said animated exercise routine.
(f) providing a calendar for allowing said subscribing user to schedule said exercise routines;
(g) evolving said icon to reflect better fitness as the subscribing user progresses.

2. The method for providing exercise through interactive Internet access according to claim 1, wherein said library of exercise content comprises a plurality of Flash™ animated exercise routines.

3. The method for providing exercise through interactive Internet access according to claim 1, wherein said calendar allows said subscribing user to track completion of said exercise routines.

4. The method for providing exercise through interactive Internet access according to claim 3, further comprising a step of assigning and displaying an animated icon to each subscriber and improving a physical appearance of the assigned icon as the subscriber completes exercise routines.

5. Software for delivering streaming video of exercise routines over the Internet, comprising;
a library of exercise routine videos;
a database cross-referencing said exercise routine videos with abstracted descriptions thereof;
a graphical user interface including an index for allowing subscribers to select a desired exercise routine video based on its cross-referenced description, and an embedded media player with controls for allowing said subscriber to play a selected exercise routine on demand.

6. The software according to claim 5, wherein said embedded media player is a Flash™ player for playing exercise animations.

7. The software according to claim 5, wherein said graphical user interface includes a text-based search function for allowing subscribers to search for and select a desired exercise routine video based on its cross-referenced description.

8. The software according to claim 7, wherein said graphical user interface includes categorical indexed selector for allowing subscribers to navigate to and select a desired exercise routine video based on its cross-referenced description.

9. The software according to claim 5, wherein said graphical user interface further includes a calendar module for allowing subscribers to schedule selected exercise routines for future playback.

10. The software according to claim 9, wherein said calendar module sends email reminders to subscribers for approaching scheduled exercise routines.

11. The software according to claim 5, wherein said exercise routines are animated.

12. The software according to claim 11, wherein said exercise routines are animated Flash™ sequences.

13. The software according to claim 9, wherein said graphical user interface further includes a tracking function for allowing subscribers to indicate when selected exercise routines have been completed.

14. The software according to claim 13, wherein said graphical user interface further includes an animated icon that visibly displays an improved condition as selected exercise routines are completed.
